(19) United States
(12) Patent Application Publication
(10) Pub. No.: US 2012/0033410 A1
(43) Pub. Date: Feb. 9, 2012

(54) FLOATATION DEVICE FOR GLASSES

(76) Inventors: Gregory Garman, Denver, CO (US); Randy Garman, Vail, CO (US)

(21) Appl. No.: 13/189,276

(22) Filed: Jul. 22, 2011

Related U.S. Application Data
(60) Provisional application No. 61/367,324, filed on Jul. 23, 2010.

(51) Int. Cl. G02C 11/00; B05D 5/06; F21V 21/08; G09F 3/00

(52) U.S. Cl. 362/103; 40/299.01; 427/243; 351/43

(57) ABSTRACT

A floatation device is provided which is adapted for placement on a portion of a pair of spectacles, sunglasses, reading or prescription glasses to prevent the loss of the glasses in a body of water. A passage in the body of the device secures it on to the glasses by being slipped over the frames. The floatation further comprises the ability to display information, such as advertising information.

This Non-Provisional application claims the benefit of priority from U.S. Patent Application No. 61/367,324 filed Jul. 23, 2010, the entire disclosure of which is hereby incorporated by reference in its entirety.

### FIELD OF THE INVENTION

The present invention relates to one or more floatation devices for attachment to a pair of glasses or spectacles having temple portions. More specifically, the present invention relates to floatation devices adapted to be secured about temple or arm portions of a pair glasses and increase the buoyancy of the glasses.

### BACKGROUND OF THE INVENTION

For as long as glasses and spectacles have been worn, there has been an inherent risk of loss of such items. It is well known that when glasses become involuntary disassociated with one's head, they may fall victim to any number of unfortunate fates including, but not limited to, sinking in a body of water. As eyewear continues to become more popular, fashionable, and expensive through, for example, advancements in polarized lenses, interchangeable lenses, and digital music playing capabilities, the need to prevent or reduce the risk of loss and damage to glasses has increased.

### SUMMARY OF THE INVENTION

Accordingly, there has been a long felt and unmet need to provide a floatation device adapted for mounting upon a portion of a pair of glasses with features and attributes as described herein.

In further support of the present disclosure, the following references generally related to the field of spectacle floatation are incorporated by reference herein: U.S. Pat. Nos. 3,016,796 to Boothe, 3,038,375 to Gansz, 3,390,938 to Gansz, 3,711,190 to Blair, 4,696,556 to Perry, III, 4,781,450 to Danloup et al., 4,966,451 to Corral et al., 5,019,000 to Stephens, D327,697 to Vines, D338,680 to Perozzi et al., D399,288 to Jacobsmeyer, D456,870 to Suissa, 6,059,408 to Bonacci, 6,513,925 to Bonacci, 6,860,596 to Nolan, 6,860,598 to Bigda, 7,980,689 to Hsu, D542,832 to Lewis, Jr. et al., 7,380,932 to Bellant, and D572,295 to Taylor, and U.S. Patent Application Publication Nos.: 2005/0270479 to Canavan et al., 2009/0021688 to Hsu, 2010/0071118 to Tobey, and 2010/0272304 to Thiel et al.

Many known accessories and attachments for glasses designed to prevent or reduce the risk of loss include devices related to or comprising a strap, such as Croakies®. Such devices attach to the ear pieces or temples of a pair of glasses and are generally adapted to be worn around one's neck. Croakies® and similar devices may be uncomfortable to wear, aesthetically unappealing, and/or may become easily dislodged from a pair of glasses when a force is applied. Many known devices generally fail to prevent loss due to sinking during various activities such as water skiing, boating, diving or during normal wear in or near various natural and/or man-made bodies of water.

Accordingly, various embodiments of the present invention contemplate one or more devices adapted for being received by a portion of a pair of glasses and which further do not require or result in significant appendages, protrusions, or straps originating from the glasses which may become entangled with various objects.

In various embodiments, the present invention provides an inexpensive, easy to use, easy to replace, unobtrusive floatation device to be attached to glasses and adapted for ease of application and removal. It is another object to create a desirable device that may be provided in any one of a number multiple shapes and colors, does not negatively interfere with the users, eyes, face or hair, and is generally unobtrusive.

In various embodiments, floatation devices of the present invention comprise a body formed of a resilient, pliable, soft floatation material with a longitudinal passage through which the device can be easily slipped onto a portion of a pair of glass (e.g. an ear piece and/or temple). In various embodiments, devices are provided further comprising a finishing coat including, but not limited to, paint, sealant, acetate or the like. Coatings and sealants as used in the present invention may be adapted for altering the appearance of floatation devices, providing characteristics such as water repellency, and/or providing a medium upon or under which information (e.g. advertising information) may be displayed. In various embodiments, buoyant material is integral with the frame of a pair of glasses, either on both sides, one side, and/or about the lens holding region of the glasses.

While various devices, such as those disclosed in U.S. Pat. Nos. 6,059,408 to Bonacci, 6,513,925 to Bonacci, 7,980,689 to Hsu, U.S. Patent Application Publication Nos.: 2005/0270479 to Canavan et al., 2009/0021688 to Hsu, all of which are hereby incorporated by reference in their entireties, disclose floatation features formed integrally with glasses, none of these devices provide for a selectively removable floatation device which is further adapted to display information and/or wherein the shape of the device itself conveys information (e.g. a brand, a destination, location, company, person, icon, organization, product, animal, food, etc.). For example, in one embodiment, the device is in the shape of a beer bottle. In still another embodiment, the device is in the shape of a pineapple. Thus, it will be recognized that floatation devices of the present invention may comprise any number of shapes, whether amorphous or well-known shapes, including but not limited to various trade dress. Accordingly, the present invention comprises a novel floatation device and method of making the same wherein the device(s) are selectively removable and further adapted to display various forms of information.

In one embodiment, floatation devices of the present invention are provided, the devices adapted to be disposed on a strap or glasses accessory, such as a Croakie® or similar device including, but not limited to, those described in U.S. Patent Application Publication No. 2010/0071118 to Tobey, the entire disclosure of which is hereby incorporated by reference in its entirety.

In various embodiments, floatation devices of the present invention comprise additional features for attaching the device and glasses that may be associated therewith to additional objects. For example, lanyards and key-rings may be disposed on the device such that the device and/or glasses may be secured to an additional object. Clips and similar features for securing the device(s) to the sun visor of a car may also be provided.

In one embodiment, a floatation device is provided that further comprises an at least partially removable sleeve or cover for glasses. In such an embodiment, the cover or sleeve may be at least partially removed from the floatation device and a pair of glasses stored therein. As one of skill in the art will recognize, such an embodiment may be particularly desirable where glasses are to be stowed and a user wishes to reduce the risk of damage to the glasses.

One of ordinary skill in the art will recognize various materials which may be applied to a portion of floatation devices of the present invention. For example, portions of floatation devices may comprise various coatings including, but not limited to, hydrophobic, oleophobic, rubber, urethane, bromo isobutylene isoprene, polybutadiene, chloro isobutylene isoprene, polychloroprene, chlorosupphonated polyethylene, epichlorohydrin, ethylene propylene, ethylene propylene diene monomer, fluorinated hydrocarbon, fluoro silicone, hydrogenated nitrile butadiene, polyisoprene, isobutylene isoprene butyl, methyl vinyl silicone, acrylonitrile butadiene, polyurethane, styrene butadiene, styrene ethylene/butylene styrene, polysiloxane, and acrylonitrile butadiene carboxy monomer.

In various embodiments, an aperture is formed in a floatation device of the present invention which allows for the device(s) to be placed over a portion of a pair of glasses. In certain embodiments, the aperture comprises a through hole generally extending along a longitudinal length of the device. The passageway or aperture is adapted to grip the glasses and hold the device securely in place with respect to the glasses. Once secured to the glasses, the device will prevent the glasses from sinking by increasing the buoyancy of the glasses/device combination to a level which allows the combination to remain afloat in a given fluid (e.g. water). Thus, in various embodiments, floatation devices of the present invention are secured to a pair of glasses based on an interference fit created by an aperture of the floatation device having a dimension (e.g. diameter, width, etc.) smaller than a corresponding dimension (e.g. diameter, width, etc.) of a pair of glasses when the device is in a first state. In some embodiments, there are one or more additional apertures and/or indentation that are present on the floatation portion, thus reducing weight and/or increasing buoyancy.

In at least one embodiment, a through hole or aperture is formed through the device(s) wherein at least a portion of the through hole is substantially non-parallel with the temple of a pair of glasses. In a particular embodiment, a through hole is provided comprising a generally curvilinear shape. Such an embodiment may, for example, facilitate the insertion of curved portions of the temple and further provide for increased grip or friction on straight portions of a temple. Thus, in one embodiment, a half-moon shaped curved orifice is provided from one entrance end to an exit end, with contact points therebetween that securely contact with glasses temple portions in a manner that precludes easy rotation of the device once fully on the temple portion.

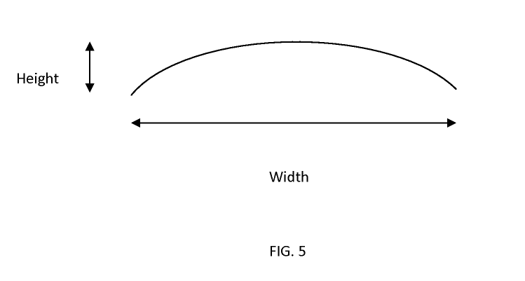

In one embodiment, a floatation device comprising an arcuate orifice is provided, the arcuate orifice comprising a width between approximately 0.5 inches and approximately five inches, and a height of between approximately 0.25 inches and 2 inches. In a preferred embodiment, a floatation device comprising an arcuate orifice is provided, the arcuate orifice comprising a width between approximately 1 inch and approximately 2 inches, and a height of between approximately 0.5 inches and 1 inch. In a more preferred embodiment, a floatation device comprising an arcuate orifice is provided, the arcuate orifice comprising a width between approximately 1 inch and approximately 1.5 inches, and a height of approximately 0.75 inches. As used herein, the terms “width” and “height” as used with respect to an arcuate orifice are further illustrated with reference to a side elevation view of an arc in FIG. 5.

It will be expressly recognized, however, that arcuate through-holes and orifices of the present invention may comprise any number of shapes are not limited to conventional geometric arcs, symmetrical arcs, etc. Various waved patterns, inverted arcs, etc. are contemplated. Additionally, apertures or orifices comprising various combinations of linear and curvilinear portions are contemplated. In one embodiment, for example, an orifice comprises a substantially linear portion terminating in a generally curvilinear portion.

One of ordinary skill in the art will recognize that various glasses comprise different sizes and shapes of temple portions and/or earpiece portions. Accordingly, in various embodiments, the present invention contemplates accommodating such different sized portions. For example, in one embodiment, the present invention comprises one or more floatation devices which may be applied to, for example, one or more temple portions of a pair of glasses through the use of a Velcro portion and/or strap. In an alternative embodiment, floatation devices of the present invention may be applied to a pair of glasses or spectacles through the use of magnetic force. For example, in one embodiment, a floatation device of the present invention comprises at least two portions, each of the at least two portions comprising at least one magnet, and wherein the magnets and corresponding portions may be selectively connected and detached. Thus, in one embodiment, floatation devices of the present invention may be selectively “clipped” on to a pair of glasses, or alternatively glued, snapped, or fitted over projections/depressions on the glasses frame, etc.

In an alternative embodiment, floatation devices of the present invention are adapted to be applied and/or secured to a portion of a pair of glasses through the use of elastomeric material, such as rubber bands. Elastomeric materials may be provided as additional devices or may be provided as an integral component of a floatation device (e.g. a floatation device and a rubber band may be provided as a single product) wherein the elastomeric material extends from a floatation device and is adapted to connect to a portion of a pair of glasses. In some embodiments, reversible attached mechanisms are employed, thus avoiding the need to thread bodies onto temple portions of glasses.

In one embodiment, at least two floatation devices are provided in order to create an appropriate amount of buoyancy for a floatation device/glasses combination while keeping the volumes of the floatation devices below a certain limit such that the devices do not interfere with a user and similarly are not so large as to be aesthetically unappealing. Thus, a user can place more or less floatation portions on glasses to address different weight and/or comfort concerns. In an alternative embodiment, a single floatation device is provided which provides sufficient buoyancy for glasses. For example, a single floatation device may be provided where the device is of sufficient buoyancy/volume and/or where the glasses intended for use with the device are comprised of plastic or similar low density materials.

In various embodiments, floatation devices are adapted for displaying information to a user or viewer. For example, floatation devices of the present invention comprise an outer layer or coating that is adapted for printing information such as advertising or graphic information in various embodiments. In one embodiment, floatation devices comprise a window or transparent section through which a removable item or portion may be viewed, the removable portion being capable of displaying different information based on a user's preference.

In one embodiment, floatation devices comprise a lighting element or light source. In one particular embodiment, light sources disposed within floatation devices of the present invention further comprise sensors, such as moisture or water sensors adapted to prompt the emission of light when, for example, the device/glasses combination is dropped into a body of water.

In various embodiments, floatation devices of the present invention have an elongate shape, a through hole extending along a longitudinal length, and a cut or recess along one wall of the device for grasping a temple of a pair of glasses. Thus, in at least one embodiment, the present invention may be applied laterally to a temple of a pair of glasses or, alternatively, threaded or slipped over a distal end of the temple or extending portion. For example, floatation devices of the present invention may open or hinge about a point opposite a cut or recess in order to place the device around the temple of a pair of glasses, the device thereafter grasping the temple under its own restorative force once released by a user. Thus, in one embodiment, a floatation device for glasses is provided having a discontinuous outer circumference for applying the device to a temple portion of the glasses.

In various embodiments, the present invention comprises features for selectively adjusting the buoyancy of a floatation device. For example, floatation devices of the present invention may be selectively filled or inflated with various fluids or gases such that buoyancy may be increased or decreased as desired. In one embodiment, floatation devices comprise one or more air bladders adapted for receiving a volume of air or gas such that buoyancy of the device and resulting device/glasses combination may increased, for example, when the glasses are near a body of water. Similarly, buoyancy and/or volume of the device(s) may be decreased when the glasses are at minimal risk of sinking or contacting water. Suitable air ports may be employed to adjust air retention and thus adjust desired buoyancy characteristics.

In certain embodiments, a pair of glasses is provided having an integral floatation device. For example, in one embodiment, a pair of glasses is provided having at least one temple extending portion, the temple comprising a portion adapted to increase the buoyancy of the glasses. In an alternative embodiment, a pair of glasses is provided having two temples, the temples further comprising a floatation element formed as part of the eyeglass/temple structure and having buoyant properties as shown and described herein. As used herein, temples refer generally to one or portions extending in a direction generally perpendicularly to a plane of one or more lenses, including but not limited to curved or angled ear portions. Thus, in various embodiments, floatation devices of the present invention need not be provided separately from a pair of glasses. Rather, a pair of glasses is contemplated, the glasses having inherent buoyancy at least in water due to built-in floatation devices.

In various embodiments, floatation devices further comprise lighting elements, such as LED lights which are activated upon the detection of the presence water in a portion of the floatation device(s). Known devices capable of emitting light in the presence of water or moisture include The Illuminator® lighted jig available from Herrick Tackle Corp. U.S. Patent Publication No. 2006/0185217 to Herrick is hereby incorporated by reference in its entirety. Sound or light emitting features triggered by submersion in water can further be employed with the various buoyancy features described herein.

The present invention further contemplates a method of displaying information, wherein desired information (e.g. advertising logos, etc.) is displayed on one or more floatation devices adapted for attachment to a pair of glasses. In one embodiment, floatation devices of a particular shape are provided in addition to or in lieu of information to be printed on the device. For example, in one embodiment, a floatation device is provided which is adapted to keep glasses afloat and further comprises the shape of a bottle, the bottle further comprising, for example, a beverage manufacturer's logo corresponding to the shape of the bottle/device. Similarly, and by way of example only, floatation devices may be provided in the shape of a football for displaying the logo or colors of one's favorite football team. It will be recognized that the present invention is not limited to a floatation device of any particular shape or to the display of any particular color, font, logo, or graphic. In other embodiments, buoyancy portions have one or more transparent envelope features to permit different printed material colored inserts, etc. to be reversibly displayed.

In various embodiments, floatation devices of the present invention comprise electronic features, such as digital music playing capabilities and/or Bluetooth components. Electronic features are protected from the elements through various foams and rubbers which may further provide for various buoyancy characteristics as shown and described herein.

In one embodiment, an array of floatation devices is provided with various floatation devices corresponding to glasses of different weight and density. For example, in one embodiment, an array of floatation is provided and a table or guide is provided for determining which type and/or quantity of floatation device(s) is needed to keep a given pair of glasses afloat in a body of water. The table or guide may reference glasses by a particular make and model number and/or may reference glasses based on weight and display a corresponding type and quantity of floatation devices required to prevent sinking of the glasses/device combination. Floatation devices of the present invention may be provided in a variety of different shapes or colors, with such attributes corresponding to a particular buoyancy value or type of spectacle with which they are to be associated.

It will be recognized that in certain applications, it is desirable to reduce the amount of material of a floatation device that is disposed on an outer portion of a temple. For example, where aesthetic considerations dictate that a minimal amount of material be disposed on an outer or outboard portion, yet buoyancy requirements dictate a certain amount of material be provided generally, a floatation device may be offset such that a majority of the device is disposed between a temple and a user's head.

Accordingly, in one embodiment, a floatation device for eyeglasses having at least one temple is provided, the device comprising a body formed of a floatation material and the body having a longitudinal passage adapted for accommodating a temple. In certain embodiments, the passage is offset from a centerline of the body such that a minor portion of the body is on an outboard side of said temple and a major portion of the body is on an inboard side the temple. One of skill in the art will recognize that the term inboard as used herein refers to a portion of a temple or surrounding area that is generally inside (e.g. proximal to a wearer's head) the temple. Similarly, as one of ordinary skill in the art will recognize, the term outboard as used herein generally refers to a portion of a temple or surrounding area that is generally outside a glasses leg/arm that extends along a user's temple region (i.e. distal from a wearer's head) the temple.

In an alternative embodiment, floatation devices of the present invention comprise a through hole or aperture along a centerline or longitudinal axis of the device. Thus, in this embodiment, the floatation device is adapted for being positioned symmetrically along a portion of a temple.

In various embodiments, a method of producing a floatation device for glasses is provided. In one embodiment, a method is provided whereby a dye is formed, the dye comprising a desired final shape and/or configuration of the device. The dye is then provided with foam, such as dense foam of between approximately ⅜ and ½ inch in width, for example. A heavy machine press operates the dye and stamps out specific portions of the foam. The specific portions are then provided with a hole or aperture. Various devices and methods may be employed to form the aperture. Portions of the foam are then disposed on a rack or dipping apparatus and a vinyl coating is applied to the portions and subsequently dried. Subsequent to drying, indicia such as, for example, stickers or silkscreen images are applied. A clear acetate coating may thereafter be applied to seal and/or secure the indicia. In various embodiments, the hole or aperture may be formed subsequent to coating, drying, and/or indicia-applying operations.

In one embodiment a clear vinyl coating, such as a coating commercially available from Flexabar Corporation is applied. The coating may comprise methyl ethyl ketone, toluene, methyl isobutyl ketone, n-butyl acetate, PVC copolymer resin, tri-2 ethylhexyl phosphate, benzenedicarboxylic, brancedalkyl esters, titanium dioxide, and various combinations thereof.

In one embodiment, the indicia applied comprise a polyester sticker, film, label, etc. The inclusion of polyester indicia in combination with various features and methods of the present invention has been shown to provide unexpected results in terms of providing indicia that reliably conforms to the foam and withstands pressure, heat, stress applied through various processes.

One of ordinary skill in the art will recognize that devices of the present invention may be disposed in a variety of locations/positions with respect to a temple. That is, floatation devices of the present invention may be aligned with a temple or offset from a temple by various different magnitudes of displacement and in any number of angular directions between 0 and 360 degrees about a temple.

In various embodiments, the present invention contemplates floatation devices for attachment to various portions of a pair of glasses and glasses accessories. Accordingly, while a preferred embodiment relates to devices for attachment to the temples of glasses, the invention is not so limited. Devices may be attached to, for example, Croakies, lanyards, and similar features attached to glasses, and/or to earpiece portions of glasses. U.S. Patent Application Publication Nos. 2010/0071118 to Tobey, 2010/0272304 to Thiel et al., and U.S. Pat. Nos. 5,019,000 to Stephens, 7,380,932 to Bellant are hereby incorporated by reference in their entireties.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as in the attached drawings and the detailed description of the invention and no limitation as to the scope of the present invention is intended to either the inclusion or non-inclusion of elements, components, etc. in this summary of the invention. Additional aspects of the present invention will become more readily apparent from the detailed description, particularly when taken together with the drawings.

### DETAILED DESCRIPTION OF THE INVENTION

It should be understood that the drawings are not necessarily to scale. In certain instances, details that are not necessary for an understanding of the invention or that render other details difficult to perceive may have been omitted from these drawings. It should further be understood that the invention is not limited to the particular embodiments illustrated in the drawings.

Various embodiments of the present invention are described herein and as depicted in the drawings. It is expressly understood that although the Figures depict various floatation devices adapted for attachment to a pair of glasses, the present invention is not limited to these embodiments.

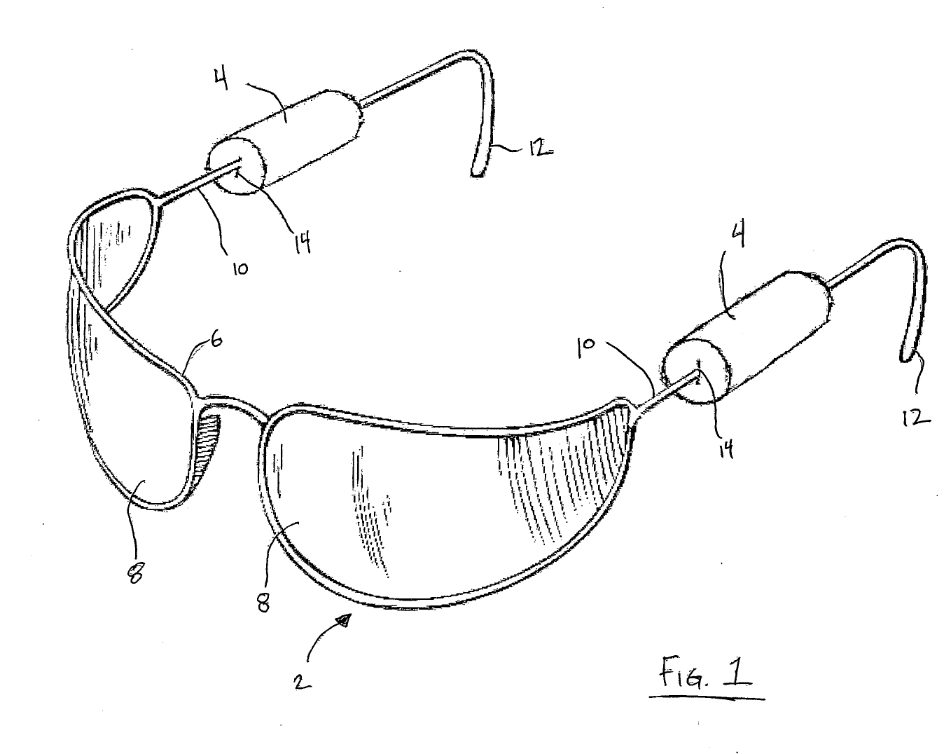

FIG. 1 is a front perspective view of floatation devices of one embodiment of the present invention;

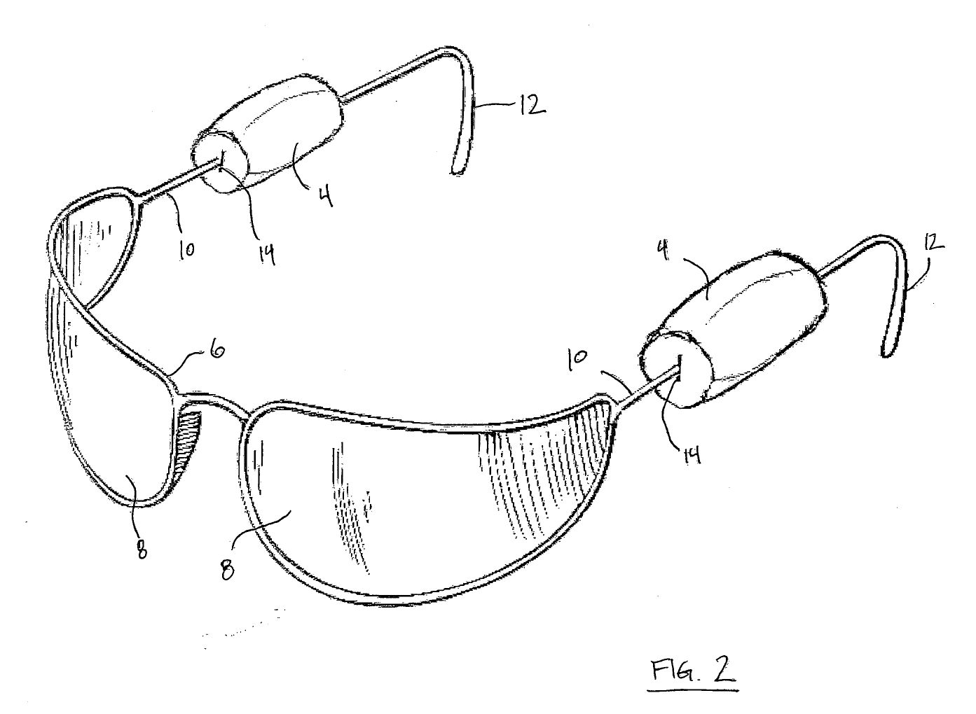

FIG. 2 is a front perspective view of floatation devices of one embodiment of the present invention;

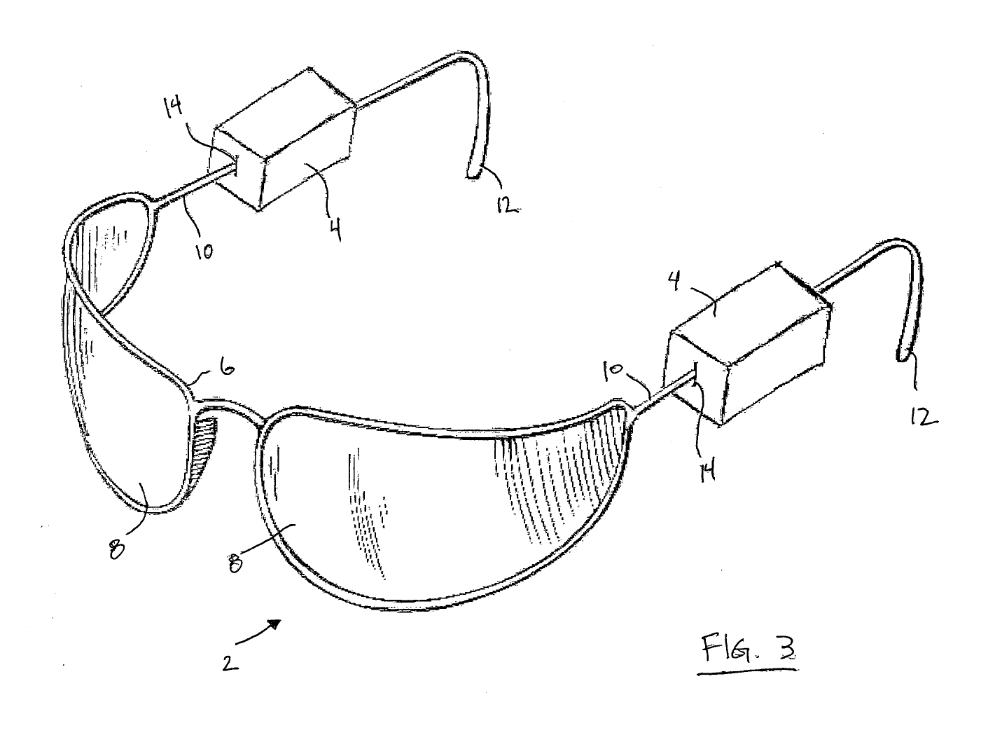

FIG. 3 is a front perspective view of floatation devices of one embodiment of the present invention;

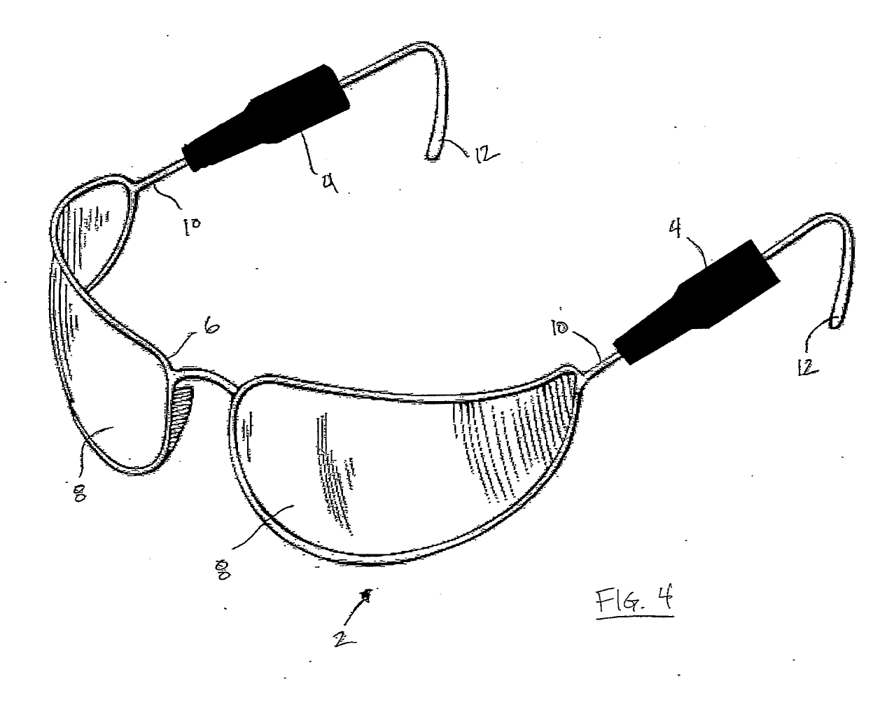

FIG. 4 is a front perspective view of floatation devices of one embodiment of the present invention;

FIG. 5 is a side elevation view of an arc as contemplated by various embodiments of the present invention.

Referring now to FIGS. 1-3, a pair of glasses 2 is shown with two floatation devices 4 attached. Floatation devices 4 are adapted for use on a pair of glasses 2 including frame 6 in which a pair of lenses 8 are mounted as shown. A pair of temples 10 is connected to the frame. Temples 10 further comprise a curved earpiece portion 12. As will be recognized by one of ordinary skill in the art, the term eyeglasses as used herein includes prescription glasses, sunglasses, safety glasses, decorative glasses, novelty glasses, reading glasses, and all other similar glasses for use and wear on a human head/face. It will further be recognized that various glasses which comprises fewer than all aspects as described herein and glasses which comprise additional features are contemplated for use with floatation devices 4. For example, it is known that various sunglasses do not comprise a frame which fully encompasses lenses 8. However, it will be recognized that these and similar departures from the conventional shape and appearance of glasses or spectacles are not critical to the present invention.

In one embodiment, floatation devices 4 include a body formed by a resilient, buoyant, pliable, elastic, soft, and/or stretchy material. One material suitable for this is flexible, low-density, closed cell foam. Closed cell foams are known for buoyant characteristics as the sealed chambers generally do not absorb water. Polyethylene, polyurethane, and ethyl vinyl acetate (“EVA”) flexible, low-density, closed cell foams are formed by blowing gases into molten plastic material. In general, softer, less dense foams have more floatation, while firmer, denser foams are more durable. For the present purpose, soft, highly buoyant material is preferred. Thus, in various embodiments, floatation devices 4 are comprised of one or more of polyethylene, polyurethane, and EVA foam.

In an alternative embodiment, floatation devices 4 of the present invention are comprised of one or more of the group consisting of plastic, wood, glass, leather, rubber, cork, and Styrofoam. The present invention is not limited to floatation devices comprising one or more foams. Rather, any material capable of trapping a volume of air or generally having buoyant characteristics is suitable for use in floatation devices 4 as shown and described herein.

In various embodiments, a coating or paint is applied to floatation devices 4 to help seal the device and provide better buoyancy and/or to help apply images to decorate the visible outside of the device.

Temples 10 of eyeglasses 2 have a straight portion and a curved ear portion 12. Distal ends of temples 10 are usually wider than the balance of curved ear portions 12. A body portion of a floatation device 4 comprises a generally elongate shape with a longitudinal passage 14. Temples 10 may be threaded through a longitudinal passage 14 such that device 4 is seated on a temple 10 at a user selected point along the temple 10. When the device 4 is in a first state, the internal diameter of longitudinal passage 14 is less than the diameter of straight portions 10 such that the body is stretched as it is placed over the temples 10 and the device 4 is secured to a temple 10 through an interference fit. Thus, in various embodiments, no external retention means are required to secure the device 4 to the temples 10. External retention means include, but are not limited to, straps, magnets, Velcro, adhesives, ties, twist-ties, wire-ties, rubber bands, and similar devices.

In various embodiments, floatation devices 4 are placed over free ends of temples 10 and slid along the temple 10 until preferably seated on straight portion, preferably about ½ to ¾ inch from frame 6. In this position, devices 4 are substantially out of the peripheral vision of the wearer. Portions of the devices 4 grip the temples 10 firmly as longitudinal passage 14 is preferably stretched. Thus, one or more devices 4 will cause eyeglasses 2 to float if they fall into a body of water. Devices 4 will not lose buoyancy for an appreciable period of time as the closed-cell foam will not waterlog.

When the wearer wants to remove devices 4 from eyeglasses 2, they may slide the device 4 off the same way they were pulled on. In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense. For example, although the Figures show a pair of floatation devices 4 attached to a pair of glasses 2, it will be recognized that any number of floatation devices 4 may be attached to a pair of glasses. Thus, the present invention is not limited to a pair of devices 4. Furthermore, although a somewhat conventional pair of glasses is shown in the Figures, it will be recognized that floatation devices of the present invention are contemplated for use on any number of shapes and designs of glasses.

FIG. 4 depicts one embodiment of a floatation device, the floatation device generally comprising the shape of a particular item (e.g. a bottle for containing beverages). One of skill in the art will recognize that the present invention is not confined to any particular size or shape and may take the form of various generic or specific shapes (e.g. sporting equipment, bottles, cans, animals, logos and logo shapes, landmarks, weapons, symbols, body parts, etc.)

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g. the use of disposable components comprising some or all of the apparatus described herein, as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A floatation device for eyeglasses having temples, comprising:
a body formed of a material that is buoyant in water;
said body having a discontinuous outer circumference and a longitudinal passage adapted for receiving said temple; and
an outer portion of said body being adapted to display visual information.

2. The floatation device of claim 1, wherein said body is formed of at least one of EVA foam, polyethylene, and polyurethane.

3. The floatation device of claim 1, wherein said body is coated in a hydrophobic material.

4. The floatation device of claim 1, wherein said body is adapted for displaying visual information.

5. The floatation device of claim 1, wherein said body comprises at least one light emitting component adapted to emit light upon the detection of a presence of water.

6. The floatation device of claim 1, wherein said longitudinal passage is generally curvilinear.

7. The floatation device of claim 1, wherein said visual information comprises advertising information.

8. A floatation device for eyeglasses having temples, comprising:
a body formed of a floatation material;
said body having a longitudinal passage adapted for accommodating a temple;
said passage being off centerline of the body wherein a minor portion of the body is on an outboard side of said temple and a major portion of the body is on an inboard side the temple.

9. The floatation device of claim 8, wherein said body is formed of at least one of EVA foam, polyethylene, and polyurethane.

10. The floatation device of claim 8, wherein said body is coated in a hydrophobic material.

11. The floatation device of claim 8, wherein said body is adapted for displaying visual information.

12. The floatation device of claim 8, wherein said body comprises at least one light emitting component adapted to emit light upon the detection of a presence of water.

13. The floatation device of claim 8, wherein said longitudinal passage is generally curvilinear.

14. The floatation device of claim 8, wherein said device is adapted for displaying visual information.

15. A method of forming a floatation device for eyeglasses having temples, comprising:
providing a dye having the desired shape of a floatation device;
providing said dye with a predetermined quantity of foam;
stamping out a portion of said predetermined quantity of foam;
forming a through-hole through said portion;
covering substantially all of an outer surface area of said portion with a vinyl coating;
allowing said vinyl coating to dry;
providing said portion with an indicia; and
providing said portion with an acetate coating.

16. The method of claim 15, wherein said foam is at least one of EVA foam, polyethylene, and polyurethane.

17. The method of claim 15, wherein said through-hole is formed with a heated blade.

18. The method of claim 15, wherein said indicia is a transparent polyester sticker.

19. The method of claim 15, wherein said indicia is a silkscreen design.

20. The method of claim 15, wherein said desired shape comprises at least one of a piece of sporting equipment, a bottle, a can, an animal, a logo, a landmark, a weapon, and a body part.
